(19) United States
(12) Patent Application Publication
(10) Pub. No.: US 2006/0076258 A1
(43) Pub. Date: Apr. 13, 2006

(54) Printable prescription vial

(76) Inventor: Edward Leroy Pencoske, Trafford, PA (US)

Correspondence Address: Edward Pencoske;Jones Day, Suite 3100, 500 Grant St., Pittsburgh, PA, 15219-2502, US

(21) Appl. No.: 11/248,668

(22) Filed: Oct. 12, 2005

Related U.S. Application Data
(60) Provisional application No. 60/618,410, filed on Oct. 13, 2004.

(51) Int. Cl. B65D 85/00; G09F 3/00; B65D 90/02

(52) U.S. Cl. 206/459.5; 40/310; 215/379

(57) ABSTRACT

The present disclosure covers a prescription vial that has a colored (preferably white) printable portion. That eliminates the need for a label as the prescription information can be printed directly onto the vial.

### CROSS-REFERENCE TO RELATED APPLICATIONS

This application claims priority from copending U.S. provisional application Ser. No. 60/618,410, filed Oct. 13, 2004, the entirety of which is hereby incorporated by reference.

### BACKGROUND

Prescriptions today are regularly filled using prescription vials which are amber colored. When a prescription is filled, a label is prepared that contains such information as the patient's name, the prescribed drug, the prescribing physician, dosage, and unique prescription number, among others. The prepared label is either manually or automatically attached to the vial.

The manual attachment of labels may be time consuming and prone to errors. The automatic attachment of labels requires dedicated equipment that prints the label and, while the vial is held in place and rotated, attaches the label to the vial. Automated equipment requires a constant stock of labels. The automated equipment may run out of labels, may become jammed, or the labels may not be properly applied to the vials. If any of these events occur, the filling of prescriptions with an automated prescription filling line may be interrupted thereby resulting in costly down time.

### SUMMARY

The present disclosure covers a prescription vial that has a colored (preferably white) printable portion. That eliminates the need for a label as the prescription information can be printed directly onto the vial.

### DESCRIPTION OF THE FIGURES

For the present disclosure to be easily understood and readily practiced, the invention will now be described, for purposes of illustration and not limitation, in conjunction with the following figures wherein:

FIG. 1 is a cross-sectional view of a vial constructing according to the present disclosure;

FIG. 2 is a cross-sectional view of an open mold for molding the vial of FIG. 1;

FIG. 3 is a cross-sectional view of the mold of FIG. 2 in the closed position;

FIGS. 4, 5, 6A and 6B illustrate other embodiments of vials constructed according to the present invention; and

FIGS. 7A-7C illustrate another embodiment of a vial constructed according to the present disclosure.

### DESCRIPTION

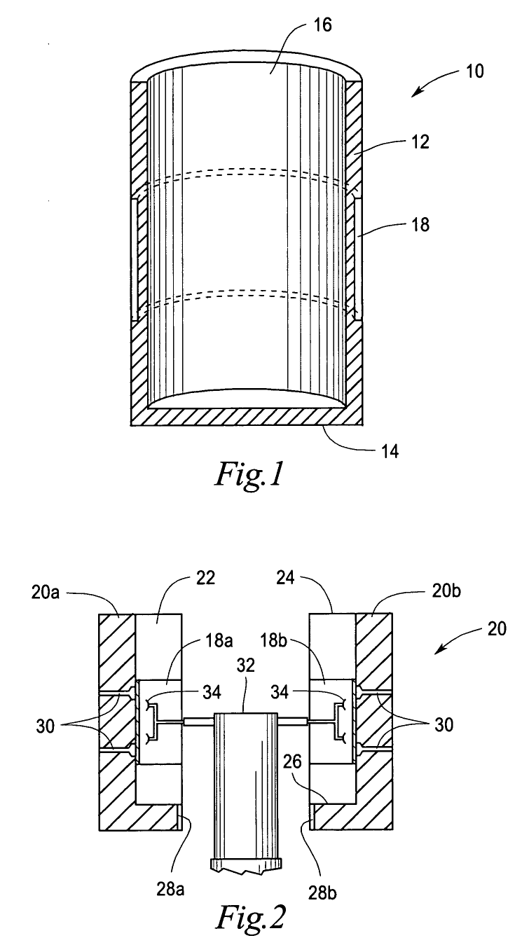

FIG. 1 illustrates a vial 10 constructed according to the present disclosure. The dimensions in FIG. 1 have been exaggerated for purposes of illustration. As shown in FIG. 1, the vial 10 is comprised of a tubular side wall 12 integrally formed with a bottom 14. The vial is open at its upper end or top 16. The periphery of the top 16 has formed therein notches (not shown) so that a cap can be used to close the upper end 16 as is known in the art. Vials used in the United States for filling prescriptions are typically amber in color and have a paper label affixed prior to, during, or after the time of filling the prescription via an adhesive. In contrast, the vial 10 of the present disclosure has a tubular printable portion 18 colored with pigment (preferably white) which eliminates the need to affix a paper label via an adhesive.

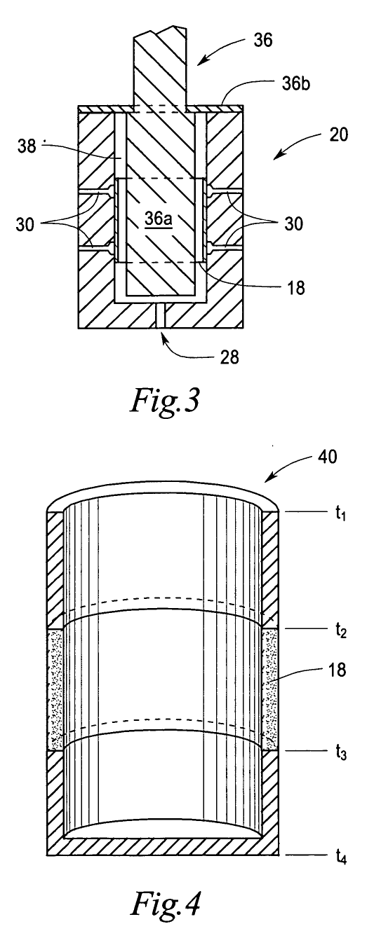

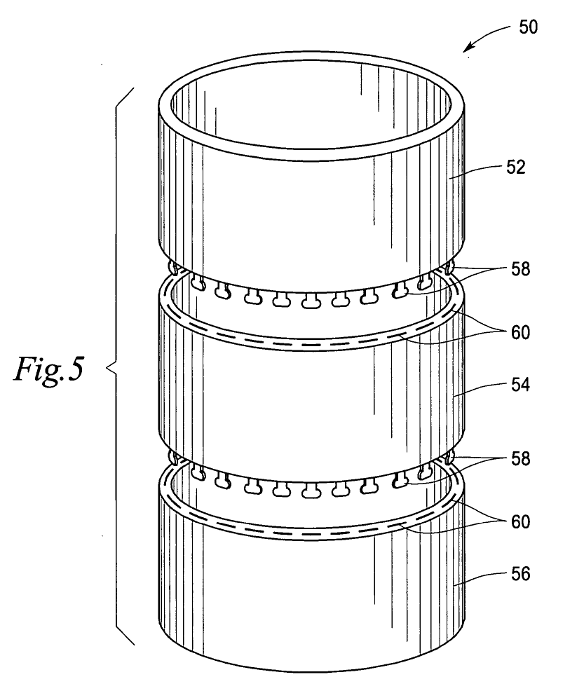

The vial 10 of FIG. 1 may be constructed in various ways. One method will now be described in conjunction with FIGS. 2 and 3. FIG. 2 illustrates a mold 20 comprised of left half 20a and right half 20b. The vertical walls of the mold 20 define a central cavity 22 which defines the outer diameter of the tubular wall 12. The mold 20 has an upper opening 24 at the top thereof and a closed bottom wall 26 at the bottom thereof. Closed bottom wall 26 has an inlet port 28 formed therein (see FIG. 3). An opening 28a for one-half of the inlet port 28 is formed in left mold half 20a while an opening 28b for the other half of the inlet port 28 is formed in right mold half 20b such that when the mold halves are brought together (see FIG. 3), the inlet port 28 is formed. The vertical walls of the mold 20 may have a plurality of vacuum ports 30 formed therein.

When the mold 20 is open as shown in FIG. 2, a tool 32 having vacuum tips 34 may be inserted into the mold 20. The tool 32 carries at the vacuum tips 34 the tubular printable portion 18 which is in two halves, left half 18a and right half 18b. The tool 32 positions the printable portion 18 over the vacuum ports 30. When a vacuum at ports 30 is drawn, and the vacuum at tips 34 removed, the printable portion will remain positioned within the mold 20 and the tool 32 can be removed. Thereafter, the mold may be closed.

Turning now to FIG. 3, after the mold 20 is closed, a mandrel 36 is positioned as shown in the figure. A lower portion 36b of the mandrel 36 is positioned within central cavity 22 and provides a cylindrical form that forms a core around which the material forming the vial 10 may be injected. The lower portion 36b of the mandrel 36 defines the inner diameter of the tubular wall 12. The mandrel 36 has a rim 36b which closes the upper opening 24 of mold 20. Thereafter, the material of which vial 10 is constructed is injected through inlet port 28 into the gap 38 formed between the inner surface of the mold 20 and the outer surface of the lower portion of the mandrel 36b. The gap 38 thus forms the shape of the vial 10. As will be apparent to those skilled in the art, the printable portion 18 will be molded into the tubular wall 12 of vial 10. After an appropriate cooling time, mandrel 36 may be withdrawn and mold 20 opened to release the vial 10 formed therein. A sprue extending from the bottom 14 of vial 10, formed by the hardening of material in inlet port 28, may need to be removed.

It is anticipated that the vial 10, including the printable portion 18, may be comprised of a wide variety of thermoplastic materials, typically polyethylene or polypropylene, with pigments added as required. It is also anticipated that printable portion 18 may be implemented using any of a known variety of materials such as synthetic papers (see, for example, U.S. Pat. No. 6,083,443 which is hereby incorporated by reference in its entirety), printable media (see, for example, U.S. Pat. No. 6,284,177 which is hereby incorporated by reference in its entirety) and various types of laminates (see, for example, U.S. Pat. No. 5,320,387 which is hereby incorporated by reference in its entirety).

Although the molding of the vial 10 is illustrated in FIGS. 2 and 3 in conjunction with an injection molding process, the present disclosure is intended to cover the use of a preform in conjunction with a blow molding process.

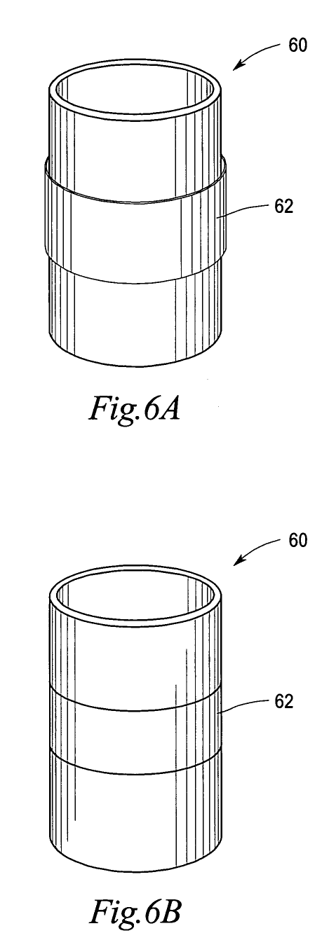

Turning now to FIG. 4, another embodiment of a vial 40 constructed according to the present disclosure is illustrated. The vial 40 of FIG. 4 may be constructed using an injection molding technique and a mold and mandrel similar to those illustrated in FIGS. 2 and 3. However, in FIG. 4, the addition of pigment to the thermoplastic as it is injected into the mold is controlled such that the tool 32 and printable portion 18A and 18B illustrated in FIG. 2 are not necessary.

In FIG. 4, injection molding begins at time t1 and continues until time t2. During that time period, the thermoplastic injected into the mold is the traditional amber color. However, at time t2, a pigment is added to the thermoplastic being injected into the mold, and the addition of pigment continues until time t3. At time t3, the addition of the white pigment is discontinued and thermoplastic of the traditional amber pigment is injected into the mold from time t3 until time t4. Those of ordinary skill in the art will recognize that because the inlet for injecting pigment is upstream of the mold, the amount of thermoplastic “in transit” must be controlled so that, at time t2, when the white pigment is added to the thermoplastic, that thermoplastic which contains the white pigment does not reach the mold until such time as the printable portion 18 is to be formed.

FIG. 5 illustrates another embodiment of a vial 50 constructed according to the teachings of the present disclosure. The vial 50 is constructed of an upper section 52, a printable middle section 54, and a lower section 56. The upper section 52 carries a plurality of male (or female) connectors 58 extending from a bottom portion thereof. The middle section 52 contains a plurality of complimentary female (or male) connectors 60 configured in a top portion thereof. Similarly, the middle section 54 carries a plurality of male (or female) connectors 58 extending from the bottom portion thereof while the lower section 56 carries a plurality of complimentary female (or male) connectors 60 in an upper surface thereof. It is anticipated that the upper section 52, middle section 54, and lower section 56 will each be separately molded such that the completed vial 50 may be formed by mechanically interconnecting the upper section 52 to the middle section 54, and the middle section 54 to the lower section 56.

FIGS. 6A and 6B illustrate yet another embodiment of a printable prescription vial 60 constructed according to the teachings of the present disclosure. A traditional, commercially available vial 60 is illustrated in FIG. 6A with a heat shrink wrap label 62 appropriately positioned. After the application of the appropriate heat, the wrap 62 shrinks in size to form a tight fit around vial 60 as shown in FIG. 6B thereby providing a printable surface.

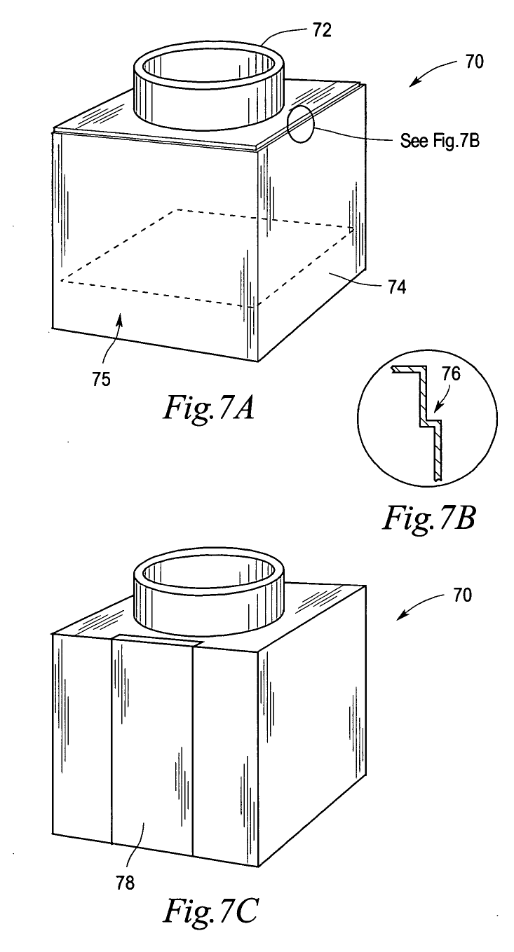

Another vial 70 constructed according to the teachings of the present disclosure is illustrated in FIG. 7A. It is anticipated that for small diameter vials, the high degree of curvature of the surface may make it difficult to print large letters. To provide a smooth printing surface, vials may be formed in a square, rectangular, triangular, or other flat sided configuration as shown in FIG. 7A. Despite having a flat sided configuration, the top 72 of the vial 70 may be a standard round configuration and contain the notches typically found on prescription vials so that commercially available lids may still be used. The vial 70 may have a bottom 74 which is either hollow or specifically configured to receive the top 72 of an adjacently placed vial. Thus, an adjacently placed vial (placed in the direction shown by arrow 75) fits completely within the hollow bottom or especially configured bottom 74 of vial 70. Additionally, a ledge 76 (See FIG. 7B) may be formed at the joint between the top and side walls so that the bottom 74 of one vial 70 is self-centering when placed on top of another vial 70. The vials 70 may have one entire side wall having printable (preferably white) pigment or, as shown in FIG. 7C, a printable strip 78 formed in one, or more, side walls.

It is anticipated that the vial 70 illustrated in FIGS. 7A and 7C may be constructed using any of the aforementioned techniques. For example, the technique described in conjunction with FIGS. 2 and 3 could be used with appropriate modification to the configuration of the mold and mandrel. Alternatively, the technique of FIG. 4 could be used together with the use of additional inlet ports to control the flow of thermoplastic material into the mold. Additionally, the technique of FIG. 5 could be used with appropriate modification such that the printable wall is mechanically attached to the remainder of an amber vial to produce the finished product. Additionally, the heat shrink wrap approach of FIG. 6 could be used. More specifically, that portion of the heat shrink wrap which is to cover the side that is to become printable would be located approximate to that side of the amber colored vial, while the remainder of the heat shrink wrap covering the other three sides could be transparent. Those of ordinary skill in the art will recognize that other methods of manufacture may lead to other physical configurations for a printable vial.

What is claimed is:

1. An unlabeled prescription vial, said vial having a printable surface or surface portion.

2. The vial of claim 1 wherein said vial is either cylindrical or has a plurality of flat walls.

3. The vial of claim 1 wherein said printable surface or surface portion is provided by a shrink wrap material.

4. The vial of claim 1 wherein said printable surface or surface portion is provided by a section of a vial wall being printable.

5. The vial of claim 1 wherein said vial is composed of multiple parts, each of said parts carrying one of male or female connectors to facilitate connection of said parts, one of said multiple parts being printable.

6. An unlabeled prescription vial, comprising:
a tubular side wall, said side wall having a printable portion; and
a bottom wall integrally connected to said side wall.

7. The vial of claim 6 wherein said printable portion is provided by a shrink wrap material.

8. The vial of claim 6 wherein said printable portion is an integral portion of said wall.

9. The vial of claim 6 wherein said printable portion is a separate wall section carrying mechanical connectors for connection to other wall sections.

10. An unlabeled prescription vial, comprising:
a plurality of interconnected flat side walls, at least one of said flat side walls having a printable portion;
a top integrally connected to said side walls; and
a bottom wall integrally connected to said side walls, said bottom wall configured to receive a top of an adjacent prescription vial.

11. The vial of claim 10 wherein said top and bottom wall are configured to be self centering.

12. The vial of claim 11 wherein said top has a ledge and said bottom wall is configured to seat on said ledge.
